(19) United States
(12) Patent Application Publication
(10) Pub. No.: US 2025/0218268 A1
(43) Pub. Date: Jul. 3, 2025

(54) METHOD FOR TERRAIN-INTEGRATED RANGING OF STRAW BURNING SMOKE IMAGES BASED ON MONOCULAR PTZ

(71) Applicant: NANTONG UNIVERSITY, Nantong (CN)

(72) Inventors: Yongjie Yang, Nantong (CN); Juntai Zheng, Nantong (CN); Kunchi Wang, Nantong (CN)

(21) Appl. No.: 18/779,380

(22) Filed: Jul. 22, 2024

Related U.S. Application Data
(63) Continuation-in-part of application No. PCT/CN2024/079796, filed on Mar. 4, 2024.

(30) Foreign Application Priority Data
Dec. 28, 2023 (CN) 202311832199.X

(51) Int. Cl. G08B 17/12; G06T 7/55; G06T 7/80; H04N 23/61; H04N 23/69; H04N 23/695

(52) U.S. Cl. CPC G08B 17/125; G06T 7/55; G06T 7/80; H04N 23/61; H04N 23/69; H04N 23/695; G06T 2207/30188

(57) ABSTRACT

A method for terrain-integrated ranging of straw burning smoke images based on monocular Pan/Tilt/Zoom (PTZ) is provided, relating to the technical field of image processing. The technical solution includes the following steps: S1, selecting a highly identifiable scene view as a calibration image by using a camera, and calibrating a pitch angle; and S2, introducing natural terrain elevation information at a location of the camera and refining accuracy of the natural terrain elevation information. The present disclosure has the following beneficial effect: the present disclosure achieves accurate detection and positioning of smoke in outdoor environments by utilizing the mechanical rotation and high-resolution image acquisition capability of the PTZ camera, combined with computer vision and image processing technologies.

### CROSS REFERENCE TO RELATED APPLICATION

This application claims priority to the Chinese Patent Application No. 202311832199.X, filed on Dec. 28, 2023, and is also a Continuation-in-Part of International Patent Application No. PCT/CN2024/079796, filed on Mar. 4, 2024, which designates the United States, and which International Application, in turn, claims priority to Chinese Patent Application No. 202311832199.X, filed on Dec. 28, 2023, all of which are incorporated herein by reference in their entirety.

### TECHNICAL FIELD

The present disclosure relates to the field of image processing, and in particular, to a method for terrain-integrated ranging of straw burning smoke images based on monocular Pan/Tilt/Zoom (PTZ).

### BACKGROUND

With the rapid development of agriculture in China, the treatment of crop straw has become an increasingly serious problem. Due to the limited methods for comprehensive utilization of straw and the phenomenon of straw burning in certain areas, the Chinese government has begun to pay attention to the issue of straw burning in recent years, and has enacted a series of policies to restrict and prohibit straw burning. Burning straw can disrupt soil structure, affect farmland quality, and even lead to safety issues such as fire. Therefore, how to monitor, identify, and locate straw burning efficiently and stably at low cost has become a major issue.

While ensuring wide coverage and high resolution, monitoring systems based on Pan/Tilt/Zoom (PTZ) cameras also face some challenges. One of the challenges is to accurately and efficiently detect and locate smoke in outdoor environments, and issue timely warnings.

Traditional smoke detection methods mainly rely on specialized equipment such as smoke sensors or photodiodes, which usually need to be deployed separately and are difficult to achieve coverage of large areas. In addition, factors such as outdoor lighting and wind can also interfere with the accuracy of traditional smoke detection devices.

Existing image processing and positioning techniques often require obtaining a large number of internal and external parameters of the camera, and a distance of the target is derived through theoretical mathematical calculations. It is difficult to accurately obtain external parameters during camera installation, leading to large errors in the calculation results of the inference formula, which are difficult to correct. In addition, for cameras already deployed at high altitudes and cases where external parameters are not accurately configured or recorded during deployment, how to effectively calibrate the pitch angle of the camera and measure distances of observed targets has become a major technical challenge. Especially in cases where it is inconvenient to install or does not support the installation of additional hardware support, these issues are more prominent. Therefore, it is necessary to study methods with higher accuracy and efficiency to improve the existing image processing and positioning techniques.

Stipanic̆ev used a web-based geographic information system data interface in the paper “Integration of forest fire video monitoring system and geographic information system” to manually click on the position coordinates on the map to resolve the location of the observed target. Automatic recognition using image data was not employed, resulting in low stability of ranging accuracy. Merino et al. proposed in the paper “An unmanned aircraft system for automatic forest fire monitoring and measurement” the use of unmanned aerial vehicles carrying infrared cameras to patrol fire points and provide coordinate information feedback, which requires additional equipment assistance, and the efficiency of patrol response is not high.

### SUMMARY

An objective of the present disclosure is to provide a method for terrain-integrated ranging of straw burning smoke images based on monocular PTZ. The present disclosure derives a pitch angle correction formula based on partial data measurement of a selected calibration scene, realizing a full-scene pitch angle solution method with a calibration position as the reference. A two-stage ranging algorithm is employed, consisting of a planar solution model assuming an ideal ground plane and a terrain-integrated solution model incorporating digital elevation data, to range images detected by a PTZ camera containing smoke information. Multi-dimensional corrections are applied to the PTZ camera, and a digital elevation model (DEM) is introduced to achieve accurate ranging.

The inventive conception of the present disclosure is as follows: The present disclosure proposes a method for terrain-integrated ranging of straw burning smoke images based on monocular PTZ. By selecting a calibration scene, measuring elevation values of the calibration scene, and calibrating parameters such as distance values and deployment heights, a pitch angle of a test image with a calibration position as a reference is solved by using a pitch angle calibration method. The method for terrain-integrated ranging of straw burning smoke images achieves ranging by using a two-stage algorithm model, which takes detected images with smoke, internal parameters of the camera as well as deployment parameters as input and incorporates digital elevation model (DEM) data around the camera deployment position. The first-stage model of the method for terrain-integrated ranging of straw burning smoke images is a planar solution model, which involves abstracting a geometric model based on a camera imaging principle, and implementing ranging under planar conditions by integrating pitch angle, roll angle, scaling, and pixel correction algorithms. The second-stage model of the method for terrain-integrated ranging of straw burning smoke images is a terrain-integrated solution model that utilizes ranging results of the planar solution model in combination with the DEM data to obtain terrain profile data of a line between the camera deployment position and a position of straw burning smoke, thereby achieving ranging for straw burning smoke under natural terrain conditions. A framework of the method for terrain-integrated ranging of straw burning smoke images is as shown in FIG. 1.

In order to achieve the aforementioned objective, the present disclosure employs the following technical solution: a method for terrain-integrated ranging of straw burning smoke images based on monocular PTZ, including the following steps:

S1: Select a highly identifiable scene view as a calibration image by using a camera, and calibrate a pitch angle.

S2: Introduce natural terrain elevation information at a location of the camera, for accuracy refinement.

The present disclosure further proposes an image calibration method based on a PTZ camera, which involves selecting a highly identifiable scene view as a calibration image by using a camera, and calibrating a pitch angle. A pitch angle calibration model is as shown in FIG. 4.

The image calibration method specifically includes the following steps.

In the first step, a highly identifiable image is captured as a calibration image.

In the second step, since an optical center of the camera stays at the same position during optical zooming, for any zoom factor, an actual distance in a world coordinate system can be calculated according to an actual position on a map corresponding to the optical center of the camera and a calibration distance D_{ref} of the camera. A process of finding a corresponding position on a map at a center position of each calibration image introduces errors due to human operation, resulting in a difference between an actual distance and a measured distance on the calibration image.

In the third step, since there is an elevation difference between a camera deployment position and a calibration position, while map-based ranging between the camera deployment position and the calibration position is top-view ranging, an elevation error will be generated if a pitch angle is calculated based on a trigonometric ranging method directly using a mounting height of the camera and calibration ranging. The error can be corrected by measuring an elevation value of the camera deployment position and an elevation value of the calibration position. A distance between the camera deployment position and a found point is measured using a map tool, to obtain the calibration distance D_{ref}, and the elevation value E_{base} of the camera deployment position, a tilt angle T_{ref} corresponding to the calibration image, and the elevation value E_{ref} of the calibration position are recorded.

In the fourth step, a pitch angle φ_{ref} of the calibration position can be calculated according to the calibration distance D_{ref} and the mounting height h of the camera, where a calculation formula is as follows:

$${φ}_{ref} = - arc tan ( \frac{h + {E}_{base} - {E}_{ref}}{{D}_{ref}} ) \qquad ( 1 )$$

In the fifth step, a pitch angle of a position of a test image can be calculated based on the known pitch angle φ_{ref} and tilt angle T_{ref} corresponding to the calibration position, and a tilt angle T of the test image, where a calculation formula is as follows:

$$φ = T - {T}_{ref} + {φ}_{ref} \qquad ( 2 )$$

By combining formula 1 and formula 2, it is obtained that:

$$φ = T - {T}_{ref} - arctan ( \frac{h + {E}_{base} - {E}_{ref}}{{D}_{ref}} ) \qquad ( 3 )$$

A roll angle offset of the PTZ camera during deployment causes an additional error to the foregoing correction for the pitch angle, and to avoid the additional error, roll angle correction is performed.

A coordinate system POT is established with the P and T values of the camera as horizontal and vertical axes, respectively, and another coordinate system is established with a horizontal plane P′ of the earth as a horizontal axis, and a vertical line T′ of the earth as a vertical axis. There is a rotation angle ω between the two coordinate systems. When the camera moves from point M to point N, a movement distance is a line segment |MN| in the coordinate axis POT, as shown in FIG. 5.

The line segment MN is regarded as a vector M̅N̅ M̅N̅ is moved to position (Nx-Mx, Ny-My), that is, the starting point M of M̅N̅ is moved to the origin of the coordinate system, and the end point N is decomposed into ΔNT and ΔNP in the coordinate system POT. ΔNT is projected onto the axis OT′ of the coordinate system P′OT′ as ΔNT′, and ΔNP is projected onto the axis OT′ of the coordinate system P′OT′ as ΔNP′, where a parameter change vector and projections thereof are shown in FIG. 6.

A projection length ΔNT of M̅N̅ on the axis OT and a projection length ΔNP on the axis OP are calculated:

$$\{ \begin{matrix}Δ NT = \vert Ny - My \vert \\ Δ NP = \vert Nx - Mx \vert\end{matrix} \qquad ( 4 )$$

Then, projection of ON′ on the axis OT′ in the coordinate system P′OT′ is calculated as |NT′| and projection of ON′ on the axis OT′ is calculated as |NP′|:

$$\{ \begin{matrix}Δ {NT}^{′} = Δ NT \times cos ( ω ) \\ Δ {NP}^{′} = Δ NP \times sin ( ω )\end{matrix} \qquad ( 5 )$$

Considering Nx as a P value of the test image, Mx as a P value of the calibration image, Ny as a T value of a test image position, and My as a T value of the calibration position, formula 4 and formula 5 are combined:

$$\{ \begin{matrix}Δ NT ' = \vert T - {T}_{r e f} \vert cos ( ω ) \\ Δ NP ' = \vert P - {P}_{r e f} \vert sin ( ω )\end{matrix} \qquad ( 6 )$$

The concept of “transfer increment” is introduced. The transfer increment is an actual offset of the horizontal or vertical axis between two states with roll angle correction. Then a pitch angle transfer increment is a difference between the T value of the test image and the T value of the calibration image multiplied by the cosine of the roll angle, plus a difference between the P value of the test image and the P value of the calibration image multiplied by the sine of the roll angle.

Assuming the transfer increment to be I, the pitch angle transfer increment I_{T} is:

$$\{ \begin{matrix}dis = \frac{h}{tan ( φ + η )} \\ φ = \vert T - {T}_{r e f} \vert cos ( ω ) + \vert P - {P}_{r e f} \vert sin ( ω ) - arctan ( \frac{h + {E}_{b a s e} - {E}_{r e f}}{{D}_{r e f}} ) \\ η = arctan ( \frac{( \frac{dst\_y}{resoultion\_h} - \frac{1}{2} ) * sensor\_h}{Z * {f}_{m i n}} )\end{matrix} \qquad ( 7 )$$

Therefore, the transfer increment I_{T} represents a change in the pitch angle when the PTZ camera, with a roll angle ω, moves from position (P_{ref}, T_{ref}) to position (P, T).

In this case, angle change correction from the calibration position to the test image position is as follows:

$$φ = {φ}_{r e f} + {I}_{T} \qquad ( 8 )$$

Formula 3 is corrected using formula 7 and formula 8, it is obtained that:

$$φ = \vert T - {T}_{r e f} \vert cos ( ω ) + \vert P - {P}_{r e f} \vert sin ( ω ) - arctan ( \frac{h + {E}_{b a s e} - {E}_{r e f}}{{D}_{r e f}} ) \qquad ( 9 )$$

T represents a tilt angle value of the test image; T_{ref} represents a tilt angle value of the calibration image.

E_{base} represents an elevation value at the camera deployment position; E_{ref} represents an elevation value at the position of the optical center of the calibration image; D_{ref} represents a horizontal distance value from the position of the optical center of the calibration image to the camera position.

Design content of the planar solution model:

First, an ideal model is introduced, assuming that the bottom of the camera mount is an ideal plane, and the observed target is in the same ideal plane. In the scene of each input image, the following information is known: camera model, mounting height (h), pan angle (P), tilt angle (T), zoom factor (Z), and resolution of the captured image. Based on the above information, the image is abstracted and modeled in the vertical direction. In general cases, the camera center is set as O. A line passing through point O and defining a boundary of the vertical field of view of the camera intersects the horizon at points A and B. Projection of a camera imaging plane in the vertical direction is represented by line segment A′B′. A perpendicular line from point O to line AB intersects line AB at point D, where |OD| is the mounting height of the camera. A line passing through point O and the optical center of the camera intersects line AB at point C and intersects line segment A′B′ at point C′. Within an actual field of view range, i.e., on line segment AB, any point P is selected as an observed object. A ray from point P intersects line segment A′B′ at point P′. For ease of comparison, the camera imaging plane is symmetrized about the center point O, forming a corresponding equivalent imaging plane containing points A″, B″, C″, and P″, and subsequent study on triangle A′OB′ is equivalent to study on triangle A″OB″. For simplicity, let □COB be Ψ, □POC be η, and □OCD be θ. Hence, the model construction is completed, and the constructed mathematical model is shown in FIG. 2.

For the system model in FIG. 2, the existing problem is transformed into solving the length |DP| of line segment DP based on the known length |A″B″| of line segment A″B″ and the known length |OD| of line segment OD. In right triangle ODP:

$$\begin{matrix}\vert DP \vert = \frac{\vert OD \vert}{tan ( θ )} & \{ θ \vert θ \neq k π + \frac{π}{2} , & θ \neq 0 , k ∈ Z \}\end{matrix} \qquad ( 10 )$$

The value of |DP| can be obtained using formula 10.

Based on the angle relationship in FIG. 2:

$$θ = φ + η \qquad ( 11 )$$

$$tan ( η ) = \frac{\vert P C \vert}{\vert C \text{"} O \vert} \qquad ( 12 )$$

By combining formula 11 and formula 12, it is obtained that:

$$η = arctan ( \frac{\vert P C \vert}{\vert C \text{"} O \vert} ) \qquad ( 13 )$$

For the angle value η, when point P lies on line segment A″C″, θ=T+η, and when point P lies on line segment B″C″, θ=T−η:

$$θ = \{ \begin{matrix}φ + η & ( P ∈ A C ) \\ φ - η & ( P ∈ B C )\end{matrix} \qquad ( 14 )$$

To simplify the formulas, the angle value η is vectorized. The direction of vector C̅″̅P̅″ is set as a positive direction, allowing the signs to be applied to physical quantities. Since arctan () function is an odd function, the following equation is established:

$$- arc tan ( \frac{\vert P C \vert}{\vert C \text{"} O \vert} ) = arc tan ( - \frac{\vert P C \vert}{\vert C \text{"} O \vert} ) \qquad ( 15 )$$

By combining formula 13, formula 14, and formula 15, it is obtained that:

$$η = arctan ( \frac{P C}{\vert C \text{"} O \vert} ) \qquad ( 16 )$$

In this case, P″C″ refers to the value of |P″C″| and has a sign, with the direction of vector C̅″̅P̅″ as the positive direction.

Thus, formula 14 is simplified as follows:

$$\begin{matrix}θ = φ + η & ( P ∈ A B )\end{matrix} \qquad ( 17 )$$

By combining formula 16 and formula 17, it is obtained that:

$$θ = φ + arctan ( \frac{P C}{\vert C \text{"} O \vert} ) \qquad ( 18 )$$

By combining formula 1 and formula 9, it is obtained that:

$$\vert DP \vert = \frac{\vert OD \vert}{tan ( φ + arctan ( \frac{P C}{\vert C \text{"} O \vert} ) )} \qquad ( 19 )$$

Formula 19 is simplified as follows:

$$d i s = \frac{h}{tan ( φ + arctan ( \frac{Δy\_phy}{f} ) )} \qquad ( 20 )$$

dis=|DP|, denoting a distance in the horizontal direction from the camera to the observed target; h=|OD|, denoting the mounting height of the camera; Δy_phy=P″C″, denoting an actual physical size of a sensor corresponding to a distance between the observed target on the y-axis of the imaging plane and the optical center; and ƒ=|OC″|, denoting a current focal length.

For the PTZ camera with optical zoom capabilities, in the construction of the above model, and the ranging model calculation only considers the fixed field of view and a single focal length of the camera. Since zooming may cause changes in some parameters, corrections need to be added to optimize the model.

Changes in the optical zoom parameter Z affect changes in the focal length, requiring correction of the focal length with respect to parameter Z.

A relationship between the maximum optical zoom parameter Zₘₐₓ and the focal range is as follows:

$${Z}_{ma x} = \frac{{f}_{ma x}}{{f}_{m i n}} \qquad ( 21 )$$

$$That is :$$

$${f}_{ma x} = {Z}_{ma x} {f}_{m i n} \qquad ( 22 )$$

Once the focal range of ƒ is determined, with respect to the minimum focal length fₘᵢₙ, a relationship of the current optical zoom factor Z with respect to the current focal length is as follows:

$$f = Z {f}_{min} \qquad ( 23 )$$

Z is a zoom factor of the camera, and fₘᵢₙ is the minimum focal length of the camera.

To solve Δy_phy, a physical size of an image sensor of the camera needs to be obtained, denoted as height sensor_h and width sensor_w. The relationship between point P″ and line segment A″B″ in FIG. 2 is equivalent to a relationship between a pixel point on the imaging plane corresponding the observed target P and the vertical resolution of the image, and is also mapped to a relationship between a position of an equivalent point of the observed target in the height direction of the image sensor of the camera and the height of the sensor, as shown in FIG. 7. In FIG. 7, plane α represents a physical size plane of the image sensor of the camera, and β represents pixel resolution of a camera output image, with pixel vertical resolution denoted as resolution_h. P″ represents a mapped position of the observed target on the corresponding plane.

Δy_pix is a difference between a y-axis coordinate value dst_y of the observed target P″ in the image coordinate system and the center of the image, namely:

$$Δy\_pix = dst\_y - \frac{resoultion\_h}{2} \qquad ( 24 )$$

A physical size difference in the height direction between a mapped position of point P″ on the physical size plane of the image sensor and the center of the physical size plane is denoted as Δy_phy. By making an equivalent mapping of point P″ on the pixel resolution plane and on the physical size plane, the following equation is obtained:

$$\frac{Δy\_phy}{sensor\_h} = \frac{Δy\_pix}{resoultion\_h} \qquad ( 25 )$$

By combining formula 21 and formula 22, it is obtained that:

$$Δy\_phy = \frac{( dst\_y - \frac{resoultion\_h}{2} ) * sensor\_h}{resoultion\_h} \qquad ( 26 )$$

dst_y represents the y-axis coordinate of the observed target in the image coordinate system, resoultion_h represents the vertical resolution of the image, and sensor_h represents the physical height of the sensor.

Correction formula and judgment criteria:

By combining all previous corrections and combining formula 11, formula 20, formula 23, and formula 26, it is obtained that:

$$\{ \begin{matrix}d i s = \frac{h}{tan ( φ + η )} \\ φ = \vert T - {T}_{ref} \vert cos ( ω ) + \vert P - {P}_{ref} \vert sin ( ω ) - arctan ( \frac{h + {E}_{base} - {E}_{ref}}{{D}_{ref}} ) \\ η = arctan ( \frac{( \frac{dst\_y}{resoultion\_h} - \frac{1}{2} ) * sensor\_h}{Z * {f}_{min}} )\end{matrix} \qquad ( 27 )$$

There are numerous parameters in formula 27, and it is necessary to ensure the definition domain for each parameter. The parameter of the tan(θ) function should satisfy the following condition:

$$θ ∈ \{ x \vert x \neq k π + \frac{π}{2} , k ∈ Z \} \qquad ( 28 )$$

In terms of practical meaning, θ represents an angle between the horizontal plane and the line passing through the optical center and the observed target, and therefore, the definition domain thereof is as follows:

$$0 < \vert θ \vert < \frac{π}{2} \qquad ( 29 )$$

In terms of practical meaning, |T−T_{ref}cos(ω) and |P−P_{ref}|sin(ω) are non-negative; h, E_{base}, E_{ref}, and D_{ref} are non-negative; resoultion_h represents the vertical resolution of the image, and is a non-zero positive number; dst_y is defined in [0, resoultion_h]; sensor_h represents the physical height of the camera sensor, and is a non-zero positive number; fₘᵢₙ represents the minimum focal length of the camera, and is a non-zero positive number; Z is defined in [0, fₘₐₓ/fₘᵢₙ], and is a non-zero positive number, with upward angles taken as positive. In summary, the constraints are expressed in formula 30.

$$- \frac{π}{2} < φ + η < 0 \qquad ( 30 )$$

Let formula 30 be the judgment criterion for formula 27. When the relevant parameters satisfy formula 30, the results calculated by formula 27 are valid.

Design content of terrain-integrated solution model:

The limitation of formula 11 lies in the assumption of an ideal ground plane. To break the assumption of the ideal ground plane, digital elevation model (DEM) data is introduced based on the geographic information system (GIS). Combined with elevation data of corresponding positions in the model, intersection points between the optical path and the elevation profile curve are calculated as the results of the terrain-integrated solution model. The terrain-integrated solution model diagram is shown in FIG. 3.

Under the premise of satisfying the above conditions, this model, when solving data, treats the target point as being at the same elevation level as the camera position. However, due to the presence of terrain variations, this simplified approach can lead to an increase in data errors. To more effectively address such issues, natural terrain elevation information at the location of the camera is further introduced for accuracy refinement. The specific implementation steps of the correction method are as follows:

Step 1: Obtain a digital elevation model image (.tif) file containing images within a specific area around the camera deployment position from an unbiased map source “TianDiTu Source.” A World Geodetic System 1984 (WGS84) latitude and longitude projection system is adopted for projection of the images in the digital elevation model image (.tif) file. This method ensures that the obtained images match actual geographical locations, providing accurate basic data for subsequent processing and analysis.

Step 2: Convert biased latitude and longitude coordinates of the camera deployment position into latitude and longitude coordinates in the unbiased WGS84 latitude and longitude projection coordinate system.

Step 3: Load and parse the digital elevation model image (.tif) file, and annotate the images in the file according to the latitude and longitude coordinates of the camera in the unbiased WGS84 latitude and longitude projection coordinate system. Thus, a contour map of an area around the camera deployment position is obtained. This map reflects elevation variations around the camera intuitively. The contour map around the camera is as shown in FIG. 8.

Step 4: Based on an initial azimuth and parameter P of the camera, obtain a map azimuth of a line connecting the camera and the observed target when the camera is aligned with the observed target (with true north as 0 degrees, a coordinate system is constructed clockwise), and draw, on the contour map, the line (referred to as optical path hereinafter) connecting the camera and the observed target that are aligned with each other. This step visually displays the relative orientation between the observed target and the camera. The optical path when the observed target and the camera are aligned is as shown in FIG. 9.

Step 5: Based on the digital elevation model image (.tif) file and relevant information of the line connecting the camera and the observed target that are aligned with each other, extract elevation values passed by the line on the contour map, convert geographical latitude and longitude information of sampling points on the line into geographical distance information between the sampling points and the camera deployment position, and construct a curve of correlation between the elevation values of the sampling points on the line and distance values from the sampling points on the line to the camera deployment position. This curve intuitively displays the terrain differences at unequal distances from the camera deployment position to the camera deployment position. The distance-elevation curve on the optical axis of the camera is shown in FIG. 10.

Step 6: Draw a model calculation diagram of the trigonometric ranging method on the curve of the correlation between the elevation values of the sampling points on the line and the distance values from the sampling points on the line to the camera deployment point, including drawing a camera position point based on the mounting height of the camera, drawing a position point of the observed target based on a distance value of the observed target calculated by a planar solution model, and drawing an optical path connecting the camera position point and the position point of the observed target. The optical path connecting the position points of the camera and the observed target is shown in FIG. 11.

Step 7: Calculate an intersection point between a line representing the optical path and an elevation curve by using an interpolation method, where the intersection point is a distance correction value incorporating the natural terrain elevation information. Depending on the terrain, the intersection point has two forms, as shown in FIG. 12 and FIG. 13.

This correction method significantly improves the accuracy when there are significant elevation changes between the camera deployment position and the observed target.

Compared with the prior art, the present disclosure has the following beneficial effects:

1. By leveraging the advantages of PTZ cameras, the high-precision outdoor smoke alarming and positioning system based on this algorithm can achieve wide-area smoke detection and positioning. This is of great significance for improving the efficiency of security monitoring systems and reducing false alarm rates.

2. To overcome these problems, a high-precision outdoor smoke alarming and positioning method based on PTZ cameras is proposed. This method achieves accurate detection and positioning of smoke in outdoor environments by utilizing the mechanical rotation and high-resolution image acquisition capability of the PTZ camera, combined with computer vision and image processing technologies.

3. The present disclosure is designed for PTZ cameras deployed at different mounting heights. It is assumed that the test image is an image output from target detection and the observed target is at the center of the image. This assumption enables the transformation of two-dimensional ranging in the image into one-dimensional ranging in the image, i.e., the research is conducted on the ranging algorithm for the vertical direction of the image. The research content is a two-stage ranging algorithm consisting of a planar solution model assuming an ideal ground plane and a terrain-integrated solution model combined with digital elevation data. This algorithm analyzes an image of identified smoke to achieve calculation of a horizontal distance and an elevation difference between the smoke position and the camera, as well as calculation of the latitude and longitude of the smoke, thus achieving smoke positioning for the collected image of identified smoke. Combined with rotation information of the PTZ camera, an accurate position of the smoke source in actual space is calculated.

4. The present disclosure proposes a high-precision outdoor smoke alarming and positioning method based on PTZ cameras. This method achieves accurate detection and positioning of smoke in outdoor environments by utilizing the mechanical rotation and high-resolution image acquisition capability of the PTZ camera, combined with computer vision and image processing technologies. The core idea of this method is to analyze the image of already identified smoke to achieve calculation of a horizontal distance and an elevation difference between the smoke position and the camera, as well as calculation of the latitude and longitude of the smoke. The smoke in the collected image of the identified smoke is located. Combined with the rotation information of the PTZ camera, the accurate position of the smoke source in actual space is calculated. Once the smoke is successfully located, the system can promptly send alarm notifications to security personnel for corresponding measures.

5. By leveraging the advantages of PTZ cameras, the high-precision outdoor smoke alarming and positioning system based on this method can achieve wide-area smoke detection and positioning. This is of great significance for improving the efficiency of security monitoring systems and reducing false alarm rates.

6. The present disclosure proposes a method for cameras already deployed at high positions, which can calibrate some external parameters without external parameter information and, combined with the rotation information of PTZ cameras, perform ranging and positioning on target images of identified smoke. This method is highly robust and can accurately measure distances and positions under various environmental conditions, providing accurate data support for subsequent smoke target analysis and processing.

7. The terrain-integrated solution model of the present disclosure combines image information and terrain data. For deployed cameras, it can perform feasible distance calculation in natural environments without the need for additional hardware support or excessive manual adjustment.

8. After 7 experiments, the average ranging error of the present disclosure is 85.14 meters, with an error accuracy of 3.90% and an error accuracy variance of 0.05%. Compared with given calculation data of the manufacture, the average error accuracy is reduced to 7.045% of given calculation data of the manufacturer, and the variance is reduced to 0.0984% of the given calculation data of the manufacturer, significantly reducing ranging error values and improving the stability of ranging results.

### BRIEF DESCRIPTION OF THE DRAWINGS

The drawings are provided for further understanding of the present disclosure and constitute a part of the specification. The drawings, together with the embodiments of the present disclosure, are intended to explain the present disclosure, rather than to limit the present disclosure.

FIG. 1 is a framework diagram of a method for terrain-integrated ranging of straw burning smoke images based on monocular PTZ according to the present disclosure;

FIG. 2 is a diagram of a mathematical model according to the present disclosure;

FIG. 3 is a diagram of a terrain-integrated solution model according to the present disclosure;

FIG. 4 is a schematic diagram of a pitch angle calibration method according to the present disclosure;

FIG. 5 is a schematic diagram showing offset of a roll angle coordinate system according to the present disclosure;

FIG. 6 is a schematic diagram showing projection conversion of the roll angle coordinate system according to the present disclosure;

FIG. 7 is a diagram showing mapping between a pixel plane and a sensor plane according to the present disclosure;

FIG. 8 shows a contour map around the camera according to the present disclosure;

FIG. 9 is a diagram showing an optical path when the camera is aligned with an observed target according to the present disclosure;

FIG. 10 shows a distance-elevation curve on an optical axis of the camera according to the present disclosure;

FIG. 11 is a diagram showing an optical path connecting position points of the camera and the observed target according to the present disclosure;

FIG. 12 is a diagram showing a solution of an actual position intersection point in the case of convex terrain according to the present disclosure;

FIG. 13 is a diagram showing a solution of an actual position intersection point in the case of concave terrain according to the present disclosure;

FIG. 14 is a satellite image of a camera deployment position according to an embodiment of the present disclosure;

FIG. 15 is a straw burning smoke image according to an embodiment of the present disclosure;

FIG. 16 is an image showing an obtained measured distance according to an embodiment of the present disclosure;

FIG. 17 shows a pitch angle calibration image according to an embodiment of the present disclosure;

FIG. 18 shows an image of an obtained calibration distance according to an embodiment of the present disclosure;

FIG. 19 shows an image of an obtained calibration roll angle according to an embodiment of the present disclosure;

FIG. 20 is a contour map according to an embodiment of the present disclosure;

FIG. 21 is a diagram showing solution of a distance-elevation relationship according to an embodiment of the present disclosure;

FIG. 22 shows a flow diagram for a method for terrain-integrated ranging of straw burning smoke images based on monocular Pan/Tilt/Zoom (PTZ) according to an embodiment of the present disclosure; and

FIG. 23 shows a framework diagram for an outdoor smoke alarming and positioning system according to an embodiment of the present disclosure.

### DETAILED DESCRIPTION OF THE EMBODIMENTS

In order to make the objectives, technical solutions, and advantages of the present disclosure more clear, the present disclosure is further described in detail below with reference to the accompanying drawings and examples. Certainly, the described embodiments herein are merely used to explain the present disclosure and are not intended to limit the present disclosure.

### Embodiment 1

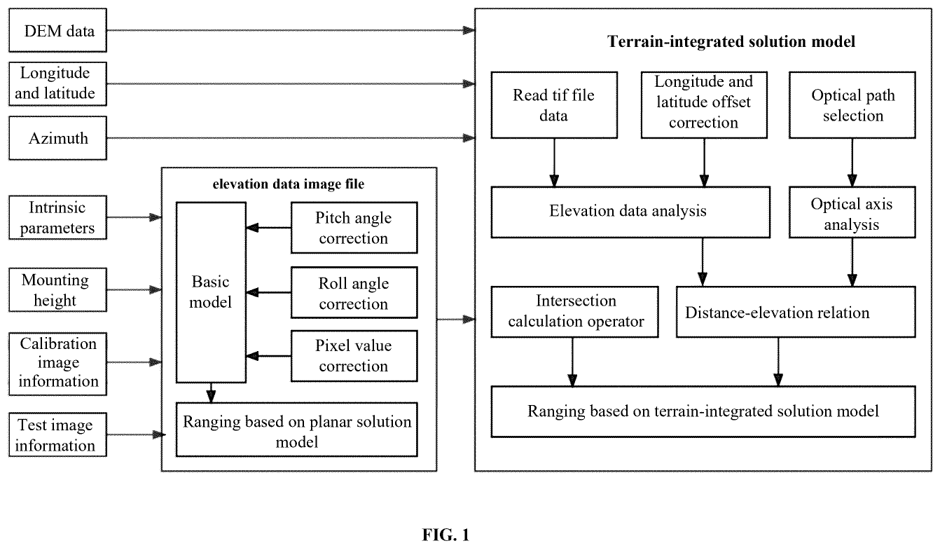

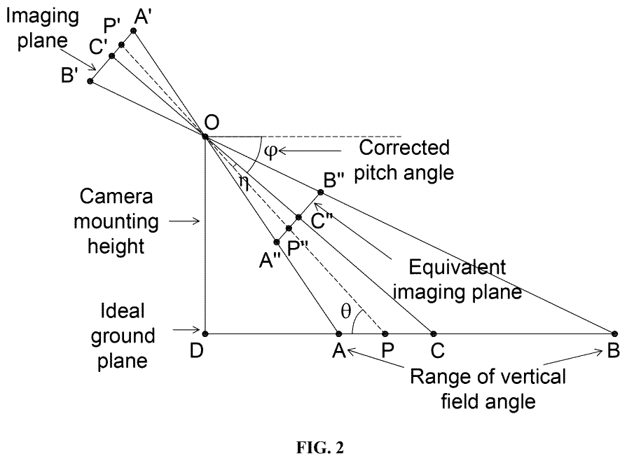

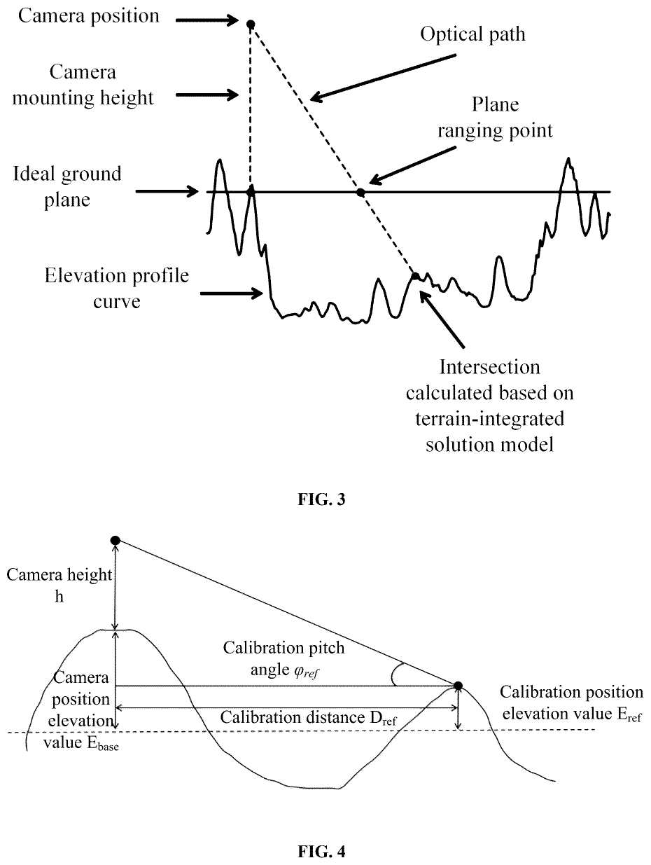

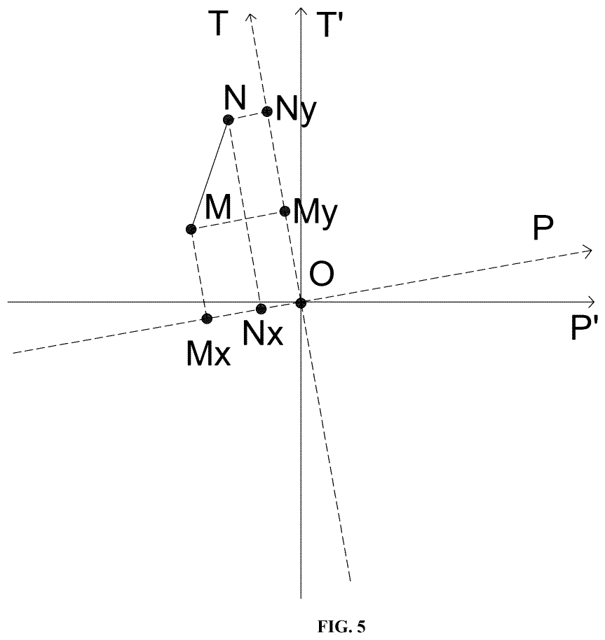

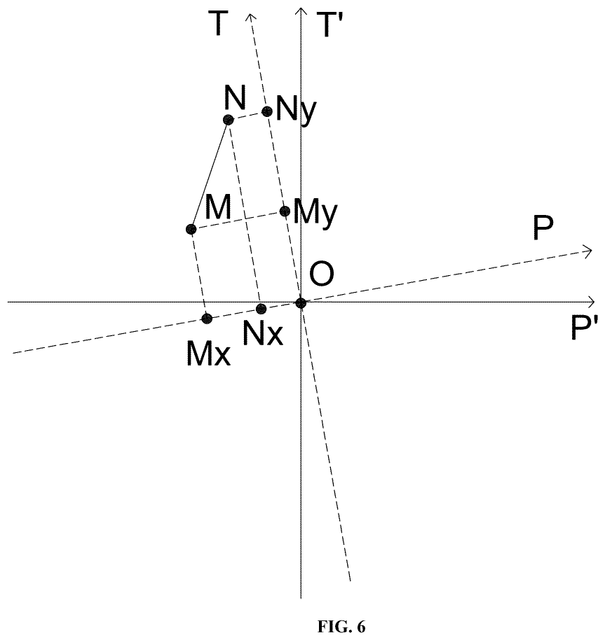

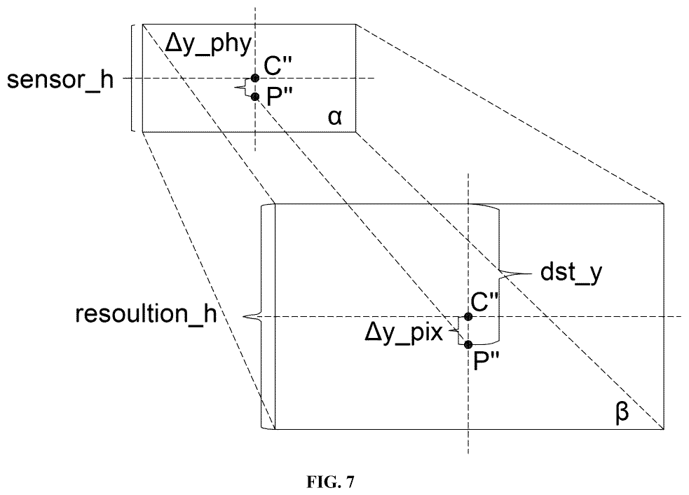

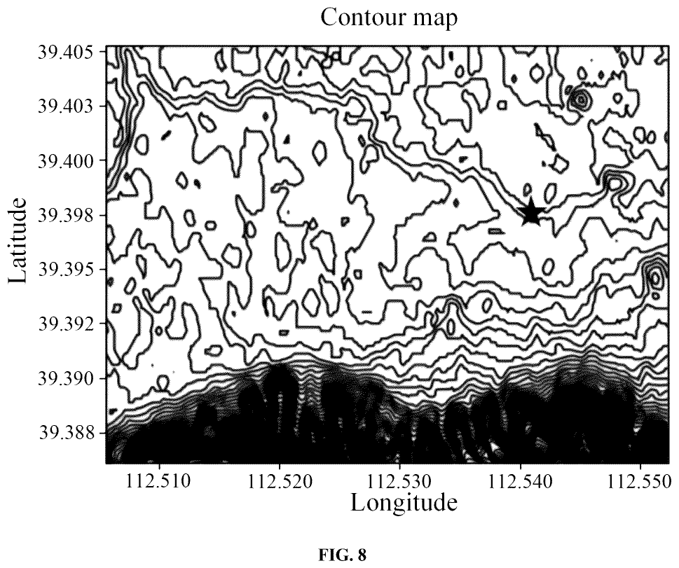

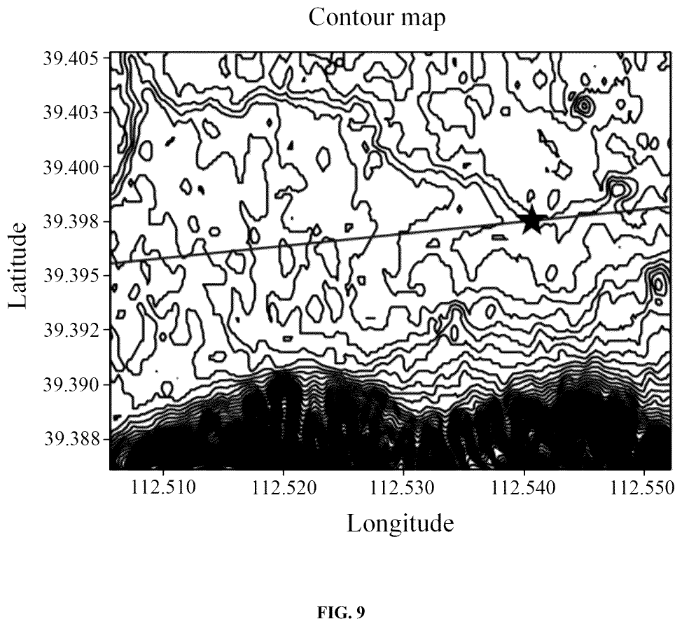

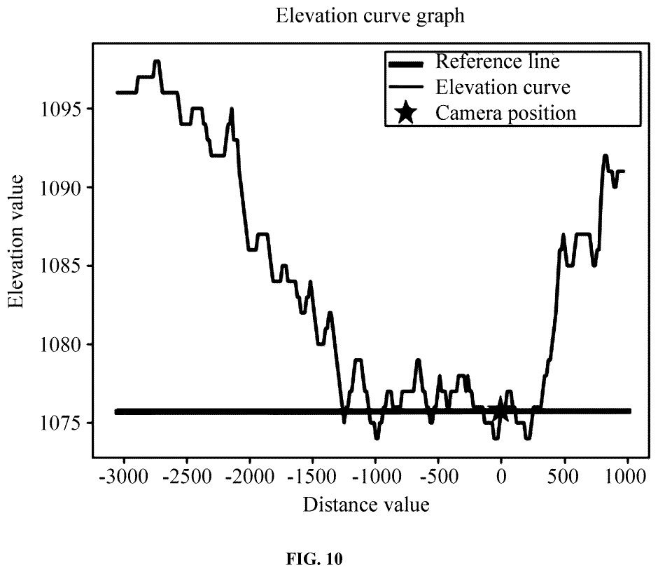

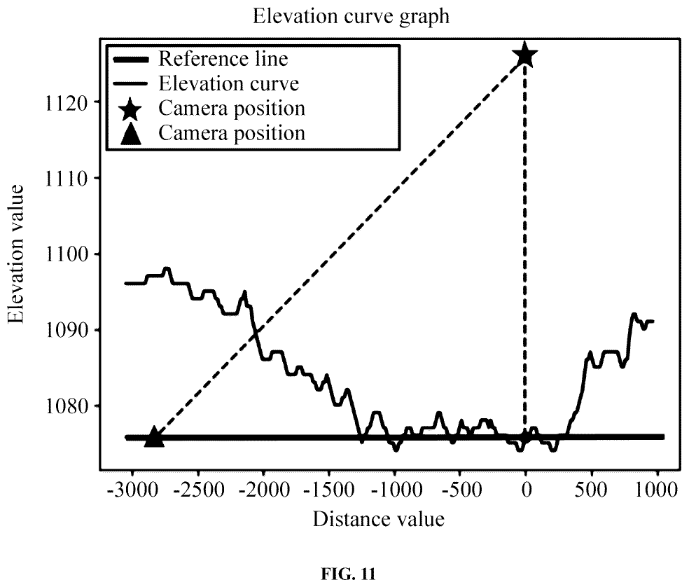

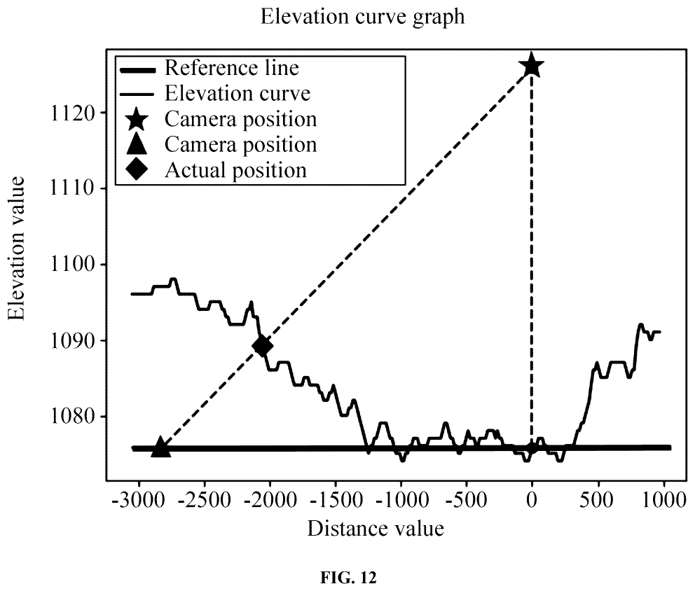

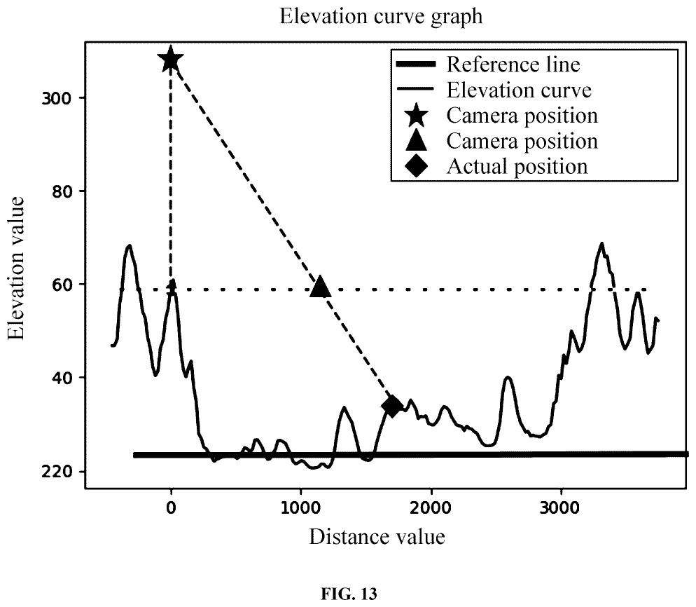

Referring to FIG. 1 to FIG. 21, in this embodiment, the method mentioned above is experimented with in an actual environment case. The implementation of the pitch angle calibration method and the method for terrain-integrated ranging of straw burning smoke images of the present disclosure is described in detail by using a smoke image of actual straw burning captured in a deployment environment of a PTZ camera as a test image.

### 1. Environment

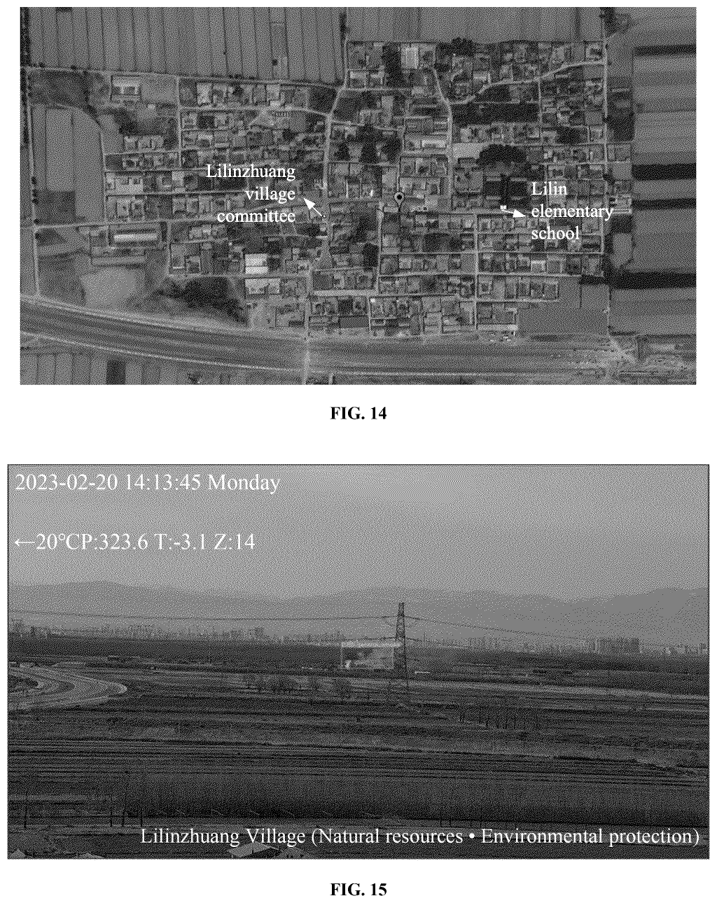

The PTZ camera deployed on the upper part of the iron tower in Lilinzhuang Village, Shuozhou City, Shanxi Province, China is taken as an example. The camera, model SD04-TT released by Zhejiang Dahua Technology Co., Ltd., has coordinates (112.606994555, 39.297415243) on Amap, and the positioning map on the satellite map software “91 Satellite Map Assistant” is shown in FIG. 14. In the data provided by the China Tower, a sample of straw burning smoke images captured by this camera is shown in FIG. 15. Ranging calculation is performed on the straw burning smoke image shown in FIG. 15.

The calculation program runs on an Intel i5-12400CPU platform. The running environment is python=3.8.17, and third-party libraries include GDAL=2.3.3, geopy=2.4.0, scipy=1.10.1, etc.

### 2. Data Acquisition

Based on the local ground plane, the camera has a mounting height h of 45 meters, and an azimuth angle of 281.57° clockwise from north.

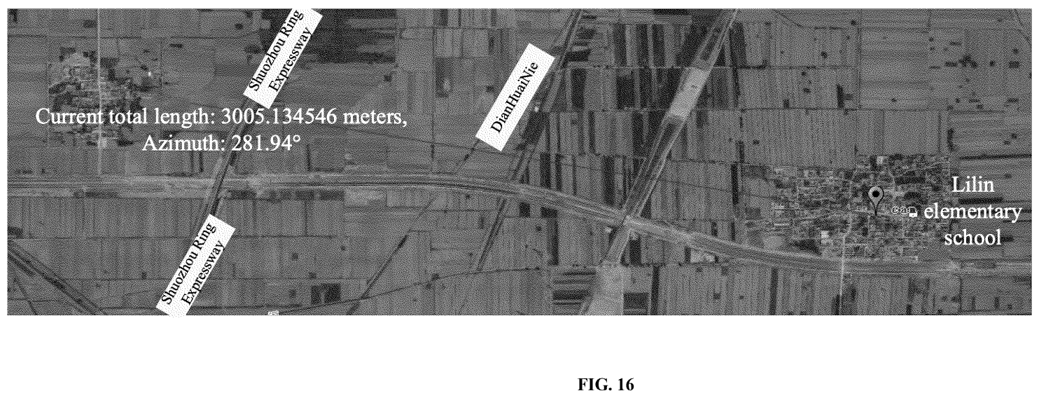

Using an online latitude and longitude conversion tool, the original Amap coordinates are converted to unbiased coordinates (112.6005794820504, 39.296613752335965). The state of the image to be calculated is: P32 323.6, T=−3.1, Z32 14. The actual distance between the target position and the camera deployment position obtained from the satellite map software “91 Satellite Map Assistant” is 3005 m, and the result is shown in FIG. 16.

### 3. Pitch Angle Calibration

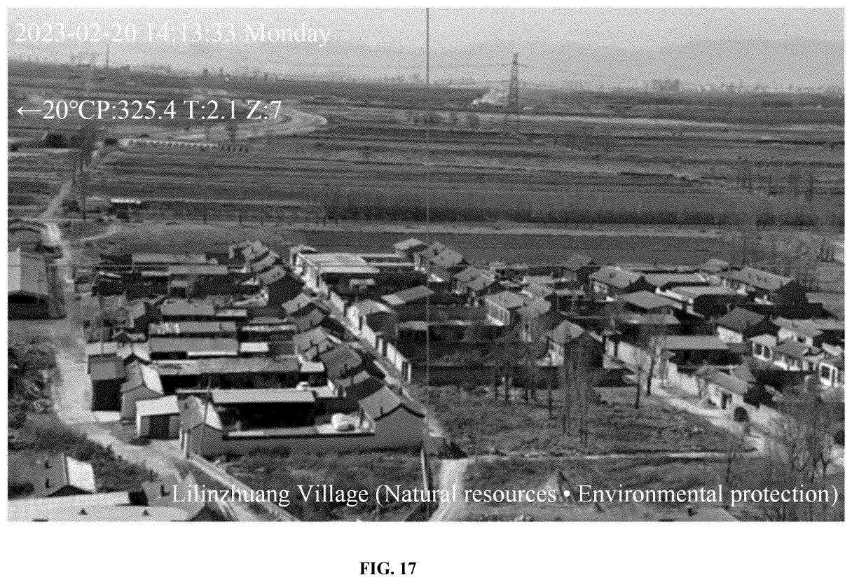

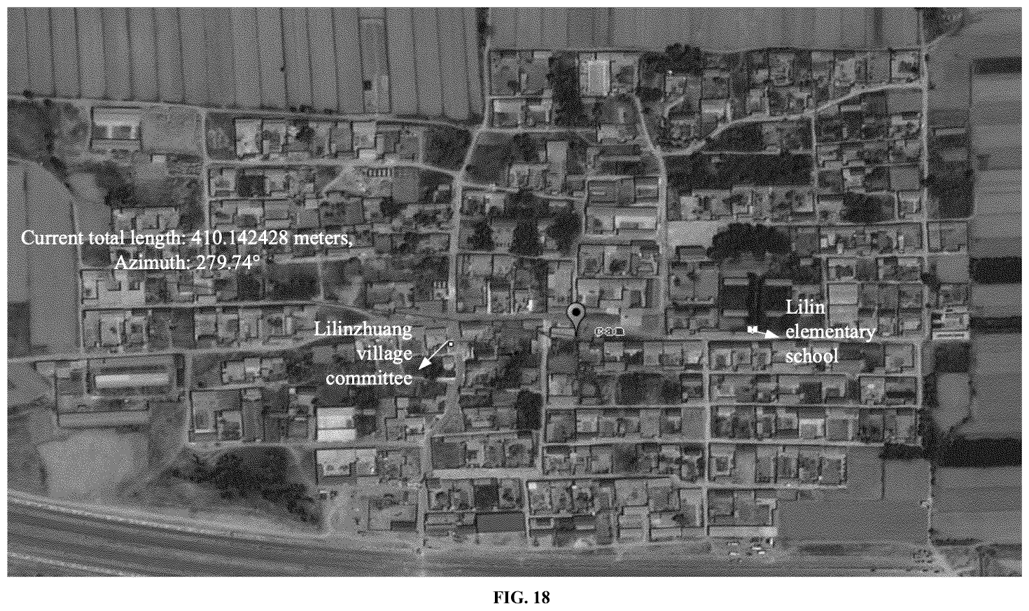

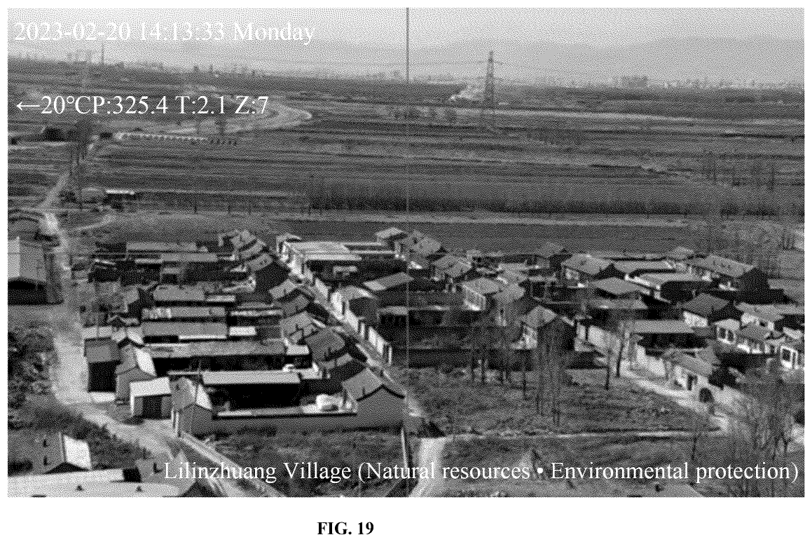

Alocal environment image provided by China Tower is selected as a pitch angle calibration image, as shown in FIG. 17. The state of the calibration image is: P_{ref}=325.4, T_{ref}=2.1, Z=7. A distance value between the optical center position of the calibration image and the camera is measured using the satellite map software “91 Satellite Map Assistant.” The measurement result is shown in FIG. 18, which is D_{ref}=410.142 m. The elevation values of the camera deployment position and the optical center position of the calibration image obtained from DEM data are E_{base}=1051.5 m and E_{ref}=1054.8 m, respectively. The software imageJ is used for roll angle measurement of the test image. The measurement method involves selecting a straight line in the image for measurement. In an angular coordinate system with the right side of the horizontal as 0 degrees and clockwise as positive, the image roll angle ω is measured to be −2.16°. The result is shown in FIG. 19. Based on the known information, calculation is performed using formula 27:

$$\begin{matrix}φ = \vert T - {T}_{ref} \vert cos ( ω ) + \vert P - {P}_{ref} \vert sin ( ω ) - arctan ( \frac{h + {E}_{base} - {E}_{ref}}{{D}_{ref}} ) \\ = \vert - 3.1 ° - 2.1 ° \vert cos ( - 2.16 ° ) + \vert 323.6 ° - {325.4}^{∘} \vert \\ sin ( - 2.16 ° ) - arctan ( \frac{45 + 1 51.5 - 1054.8}{410.142} ) \\ = - 0.677 °\end{matrix} .$$

The camera pitch angle Ψ corresponding to the test image is calculated to be −0.677°.

### 4. Ranging Based on Planar Solution Model

Based on the image information in FIG. 15, the image resolution is 2560*1440, i.e., resolution_h=1440. According to the information of the target detection box in the image, the coordinates of the midpoint of its lower edge in the image coordinate system are (1038, 751), i.e., dst_y=751. According to the camera model, it is obtained that the sensor size is 5.32 mm*7.18 mm, i.e., sensor_h=7.18 mm, and the minimum focal length fₘᵢₙ₌5.5 mm. Combined with the zoom factor Z=14 of the current image, calculation is performed using formula 27:

$$\begin{matrix}η = arctan ( \frac{( \frac{dst\_y}{resoultion\_h} - \frac{1}{2} ) * sensor\_h}{Z * {f}_{min}} ) \\ = arctan ( \frac{( \frac{751}{1440} - \frac{1}{2} ) * 7.18}{14 \times 5.5} ) \\ = 0.115 °\end{matrix} .$$

It is calculated that η=0.115°.

Combined with the previous calculation result Ψ=−0.677°, the result is judged using formula 30:

$$\{ \begin{matrix}φ = - 0.677 ° \\ η = 0.115 ° \\ φ + η = - 0.562 ° ∈ ( - \frac{π}{2} , 0 )\end{matrix} .$$

The judgment condition is met, and distance calculation begins. Calculation is performed using formula 27:

$$\begin{matrix}dis = \frac{h}{tan ( φ + η )} \\ = \frac{45}{tan ( - 0.677 ° + 0.115 ° )} \\ = 3255.172\end{matrix} .$$

Through the planar solution model, the calculated distance value is dis=3255.172 m Evaluation: The actual distance is 3005 m, and the error is 250 m.

### 5. Ranging Based on Terrain-Integrated Solution Model

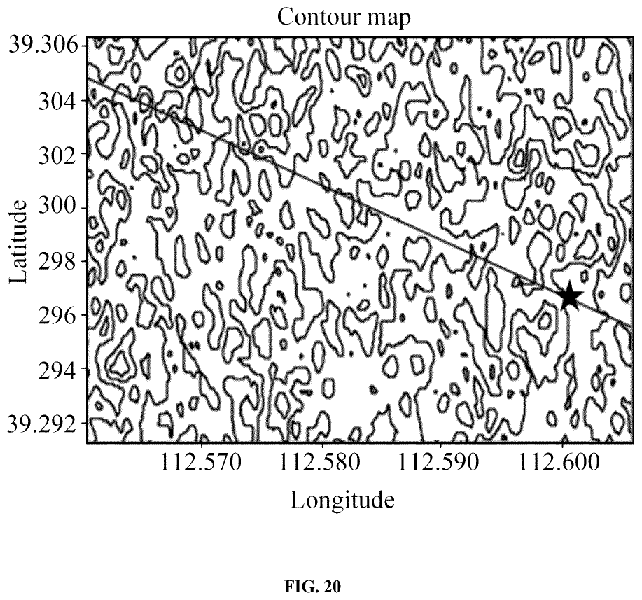

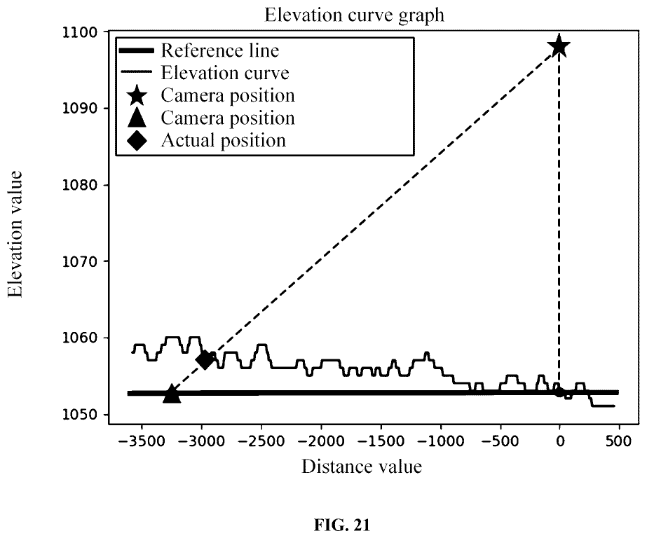

An elevation contour map of the unbiased latitude and longitude of the camera deployment position exported from the DEM data is shown in FIG. 20. In the figure, the point represents the camera deployment position, and the line represents an azimuth angle mapping line of a line connecting the camera and the target on the map. Based on this figure, the elevation profile data corresponding to the optical path is converted into a two-dimensional coordinate system constructed with the distance from the camera deployment position as the horizontal axis and the profile elevation value as the vertical axis, showing the distance-elevation relationship (Elevation Profile). The camera position CamH is drawn in the figure according to existing parameters. With an equivalent plane base constructed from the camera deployment position, and the target point p_dst_d obtained by the planar solution model, a distance-elevation relationship graph is as shown in FIG. 21. In this figure, the point CamH corresponding to the camera position is connected to the target point p_dst_d obtained by the planar solution model, and an interpolation method is used to obtain the actual target point p_real incorporating elevation data. The x-coordinate value of the actual target point p_real obtained by this method is −2956.77 m, where the symbol indicates the direction and the value indicates the distance from the camera deployment position. Evaluation: The actual distance is 3005 m, and the error is 49 m.

### Embodiment 2

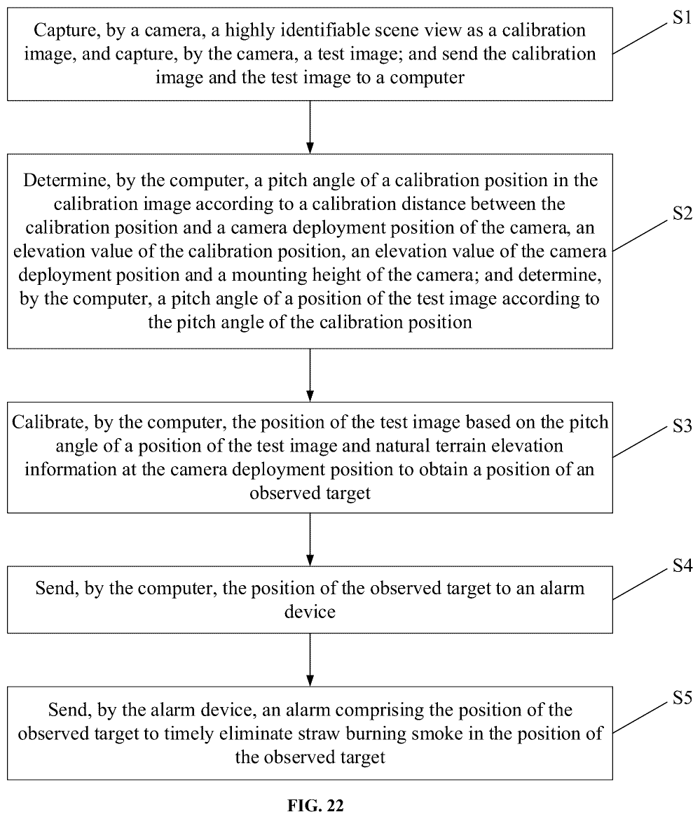

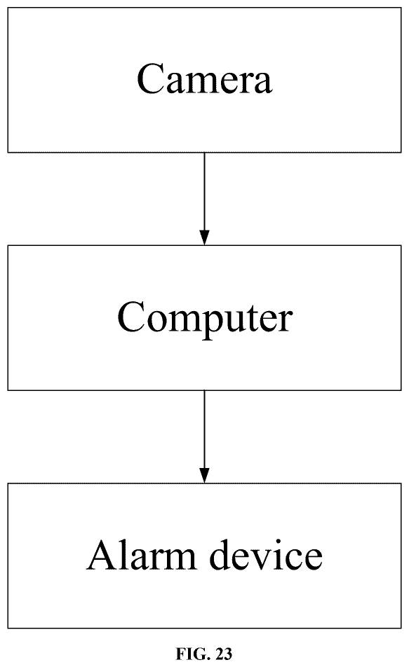

Referring to FIGS. 22 and 23, this embodiment provides a method for terrain-integrated ranging of straw burning smoke images based on monocular Pan/Tilt/Zoom (PTZ), and an outdoor smoke alarming and positioning system based on this method.

This method includes the following steps:
S1: capturing, by a camera, a highly identifiable scene view as a calibration image, and capturing, by the camera, a test image; and sending the calibration image and the test image to a computer;
S2: determining, by the computer, a pitch angle of a calibration position in the calibration image according to a calibration distance between the calibration position and a camera deployment position of the camera, an elevation value of the calibration position, an elevation value of the camera deployment position and a mounting height of the camera; and determining, by the computer, a pitch angle of a position of the test image according to the pitch angle of the calibration position;
S3: calibrating, by the computer, the position of the test image based on the pitch angle of a position of the test image and natural terrain elevation information at the camera deployment position to obtain a position of an observed target;
S4: sending, by the computer, the position of the observed target to an alarm device; and
S5: sending, by the alarm device, an alarm comprising the position of the observed target to timely eliminate straw burning smoke in the position of the observed target.

The outdoor smoke alarming and positioning system operates based on the above method. Specifically, the outdoor smoke alarming and positioning system includes a camera, a computer and an alarm device.

The camera is configured to capture a highly identifiable scene view as a calibration image, capture a test image, and send the calibration image and the test image to the computer.

The computer is configured to determine a pitch angle of a calibration position in the calibration image according to a calibration distance between the calibration position and a camera deployment position of the camera, an elevation value of the calibration position, an elevation value of the camera deployment position and a mounting height of the camera, and determine a pitch angle of a position of the test image according to the pitch angle of the calibration position, and calibrate the position of the test image based on the pitch angle of a position of the test image and natural terrain elevation information at the camera deployment position to obtain a position of an observed target, and send the position of the observed target to the alarm device.

The alarm device is configured to send an alarm comprising the position of the observed target to timely eliminate straw burning smoke in the position of the observed target.

The above are merely preferred embodiments of the present disclosure, and are not intended to limit the present disclosure. Any modifications, equivalent replacements, improvements, and the like made within the spirit and principle of the present disclosure shall be all included in the protection scope of the present disclosure.

What is claimed is:

1. A method for terrain-integrated ranging of straw burning smoke images based on monocular Pan/Tilt/Zoom (PTZ), comprising the following steps:
S1: capturing, by a camera, a highly identifiable scene view as a calibration image, and capturing, by the camera, a test image; and sending the calibration image and the test image to a computer;
S2: determining, by the computer, a pitch angle of a calibration position in the calibration image according to a calibration distance between the calibration position and a camera deployment position of the camera, an elevation value of the calibration position, an elevation value of the camera deployment position and a mounting height of the camera; and determining, by the computer, a pitch angle of a position of the test image according to the pitch angle of the calibration position;
S3: calibrating, by the computer, the position of the test image based on the pitch angle of a position of the test image and natural terrain elevation information at the camera deployment position to obtain a position of an observed target;
S4: sending, by the computer, the position of the observed target to an alarm device; and
S5: sending, by the alarm device, an alarm comprising the position of the observed target to timely eliminate straw burning smoke in the position of the observed target.

2. The method for terrain-integrated ranging of straw burning smoke images based on monocular PTZ according to claim 1, wherein step S2 comprises the following steps:
S12: on the basis of a constant position of an optical center of the camera during optical zooming, for any zoom factor, calculating an actual distance in a world coordinate system according to an actual position on a map corresponding to the optical center of the camera and a calibration distance D_{ref} of the camera, wherein a process of finding a corresponding position on a map at a center position of each calibration image introduces errors due to human operation, resulting in a difference between an actual distance and a measured distance on the calibration image;
S13: since there is an elevation difference between a camera deployment position and a calibration position, and map-based ranging between the camera deployment position and the calibration position is top-view ranging, in order to correct an elevation error generated in calculation of a pitch angle based on a trigonometric ranging method directly using a mounting height of the camera and calibration ranging, measuring an elevation value of the camera deployment position and an elevation value of the calibration position, measuring a distance between the camera deployment position and a found point using a map tool, to obtain the calibration distance D_{ref}, and recording the elevation value E_{base} of the camera deployment position, a tilt angle T_{ref} corresponding to the calibration image, and the elevation value E_{ref} of the calibration position;
S14: calculating a pitch angle φ_{ref} of the calibration position according to the calibration distance D_{ref} and the mounting height h of the camera, wherein a calculation formula is as follows:
$${φ}_{ref} = - arctan ( \frac{h + {E}_{base} - {E}_{ref}}{{D}_{ref}} ) \qquad ( 1 )$$
S15: calculating a pitch angle of a position of a test image based on the known pitch angle φ_{ref} corresponding to the calibration position, the tilt angle T_{ref} corresponding to the calibration image, and a tilt angle T of the test image, wherein a calculation formula is as follows:
$$φ = T - {T}_{ref} + {φ}_{ref} \qquad ( 2 )$$
wherein by combining formula (1) and formula (2), it is obtained that:
$$φ = T - {T}_{ref} - arctan ( \frac{h + {E}_{base} - {E}_{ref}}{{D}_{ref}} ) \qquad ( 3 )$$
a roll angle offset of a PTZ camera during deployment causes an additional error to the foregoing correction for the pitch angle, and to avoid the additional error, roll angle correction is performed.

3. The method for terrain-integrated ranging of straw burning smoke images based on monocular PTZ according to claim 1, wherein step S3 comprises the following steps:
step 1: obtaining a digital elevation model image (.tif) file containing images around the camera deployment position from an unbiased map source “TianDiTu Source,” wherein a World Geodetic System 1984 (WGS84) latitude and longitude projection system is adopted for projection of the images in the digital elevation model image (.tif) file, ensuring that the obtained images match actual geographical locations and provide accurate basic data for subsequent processing and analysis;
step 2: converting based latitude and longitude coordinates of the camera deployment position into latitude and longitude coordinates in the unbiased WGS84 latitude and longitude projection coordinate system;
step 3: loading and parsing the digital elevation model image (.tif) file, annotating the images in the digital elevation model image (.tif) file according to the latitude and longitude coordinates of the camera in the unbiased WGS84 latitude and longitude projection coordinate system, to obtain a contour map of an area around the camera deployment position, and observing a degree of elevation change in the area;
step 4: based on an initial azimuth and parameter P of the camera, obtaining a map azimuth of a line connecting the camera and an observed target when the camera is aligned with the observed target, and drawing, on the contour map, the line connecting the camera and the observed target that are aligned with each other;
step 5: extracting elevation values passed by the line on the contour map according to relevant information of the line, converting geographical latitude and longitude information of sampling points on the line into geographical distance information between the sampling points and the camera deployment position, and constructing a curve of correlation between the elevation values of the sampling points on the line and distance values from the sampling points on the line to the camera deployment position;
step 6: drawing a model calculation diagram of the trigonometric ranging method on the curve of the correlation between the elevation values of the sampling points on the line and the distance values from the sampling points on the line to the camera deployment position, comprising drawing a camera position point based on the mounting height of the camera, drawing a position point of the observed target based on a distance value of the observed target calculated by a planar solution model, and drawing an optical path connecting the camera position point and the position point of the observed target; and
step 7: calculating an intersection point between a line representing the optical path and an elevation curve by using an interpolation method, where the intersection point is a distance correction value incorporating the natural terrain elevation information.

4. The method for terrain-integrated ranging of straw burning smoke images based on monocular PTZ according to claim 2, wherein step S3 comprises the following steps:
step 1: obtaining a digital elevation model image (.tif) file containing images around the camera deployment position from an unbiased map source “TianDiTu Source,” wherein a World Geodetic System 1984 (WGS84) latitude and longitude projection system is adopted for projection of the images in the digital elevation model image (.tif) file, ensuring that the obtained images match actual geographical locations and provide accurate basic data for subsequent processing and analysis;
step 2: converting based latitude and longitude coordinates of the camera deployment position into latitude and longitude coordinates in the unbiased WGS84 latitude and longitude projection coordinate system;
step 3: loading and parsing the digital elevation model image (.tif) file, annotating the images in the digital elevation model image (.tif) file according to the latitude and longitude coordinates of the camera in the unbiased WGS84 latitude and longitude projection coordinate system, to obtain a contour map of an area around the camera deployment position, and observing a degree of elevation change in the area;
step 4: based on an initial azimuth and parameter P of the camera, obtaining a map azimuth of a line connecting the camera and an observed target when the camera is aligned with the observed target, and drawing, on the contour map, the line connecting the camera and the observed target that are aligned with each other;
step 5: extracting elevation values passed by the line on the contour map according to relevant information of the line, converting geographical latitude and longitude information of sampling points on the line into geographical distance information between the sampling points and the camera deployment position, and constructing a curve of correlation between the elevation values of the sampling points on the line and distance values from the sampling points on the line to the camera deployment position;
step 6: drawing a model calculation diagram of the trigonometric ranging method on the curve of the correlation between the elevation values of the sampling points on the line and the distance values from the sampling points on the line to the camera deployment position, comprising drawing a camera position point based on the mounting height of the camera, drawing a position point of the observed target based on a distance value of the observed target calculated by a planar solution model, and drawing an optical path connecting the camera position point and the position point of the observed target; and
step 7: calculating an intersection point between a line representing the optical path and an elevation curve by using an interpolation method, where the intersection point is a distance correction value incorporating the natural terrain elevation information.

5. An outdoor smoke alarming and positioning system, comprising:
a camera, configured to capture a highly identifiable scene view as a calibration image, capture a test image, and send the calibration image and the test image to a computer;
the computer, configured to determine a pitch angle of a calibration position in the calibration image according to a calibration distance between the calibration position and a camera deployment position of the camera, an elevation value of the calibration position, an elevation value of the camera deployment position and a mounting height of the camera, and determine a pitch angle of a position of the test image according to the pitch angle of the calibration position, and calibrate the position of the test image based on the pitch angle of a position of the test image and natural terrain elevation information at the camera deployment position to obtain a position of an observed target, and send the position of the observed target to an alarm device; and
the alarm device, configured to send an alarm comprising the position of the observed target to timely eliminate straw burning smoke in the position of the observed target.
